(19) United States
(12) Patent Application Publication
(10) Pub. No.: US 2008/0100453 A1
(43) Pub. Date: May 1, 2008

(54) Long Wave Wireless Pair-Wise Linkage Using an Embedded Visibility Network

(75) Inventors: John K. Stevens, Stratham, NH (US); Paul Waterhouse, Selkirk (CA); David Cramer, Orangeville (CA); M. Jason August, Toronto (CA); Tom Packert, Miami, FL (US); Jay Pierce, Miami, FL (US)

Correspondence Address: Marina Larson & Associates, LLC, re:VAI, P.O. Box 4928, Dillon, CO, 80435-4928, US

(73) Assignee: VISIBLE ASSETS, INC., Mississauga (CA)

(21) Appl. No.: 11/765,192

(22) Filed: Jun. 19, 2007

Related U.S. Application Data
(60) Provisional application No. 60/805,102, filed on Jun. 19, 2006.

(51) Int. Cl. G08B 13/14

(52) U.S. Cl. 340/572.7

(57) ABSTRACT

A system uses an antenna at a portal, the antenna coupled to equipment which can send and receive information to and from radio tags, each having a unique identity. The equipment detects, for example, a tag attached to an asset. The equipment looks to see if an associated badge is in the detection area of the portal. If the badge and asset match, the user bearing the badge is permitted to exit the portal. Otherwise the user is not permitted to exit the portal. An asset such as a ski can be equipped with such a tag, the tag in this case being a low-frequency tag. The low-frequency tag permits locating the ski even if it is not visible because it is under snow.

This application claims priority from U.S. application Ser. No. 60/805,102, filed Jun. 19, 2006, which application is incorporated herein by reference for all purposes.

### BACKGROUND

is not easy to keep track of assets entering and leaving a building or storage area.

### SUMMARY OF THE INVENTION

A system uses an antenna at a portal, the antenna coupled to equipment which can send and receive information to and from radio tags, each having a unique identity. The equipment detects, for example, a tag attached to an asset. The equipment looks to see if an associated badge is in the detection area of the portal. If the badge and asset match, the user bearing the badge is permitted to exit the portal. Otherwise the user is not permitted to exit the portal. An asset such as a ski can be equipped with such a tag, the tag in this case being a low-frequency tag. The low-frequency tag permits locating the ski even if it is not visible because it is under snow.

### BRIEF DESCRIPTION OF THE DRAWING

The invention will be described with respect to a drawing in several figures, of which:

FIG. 1 shows in perspective view a portal 112 with an antenna;

FIG. 2 shows in schematic plan view the portal of FIG. 1 along with a human user 116 and an asset 113;

FIG. 3 shows a ski 121 according to the invention, with snow 123.

Where possible, like reference designations have been used to denote like elements.

### DETAILED DESCRIPTION

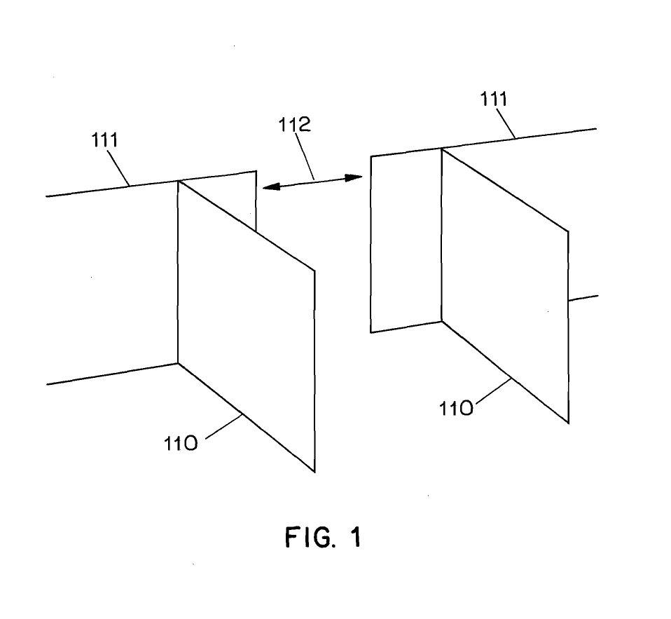

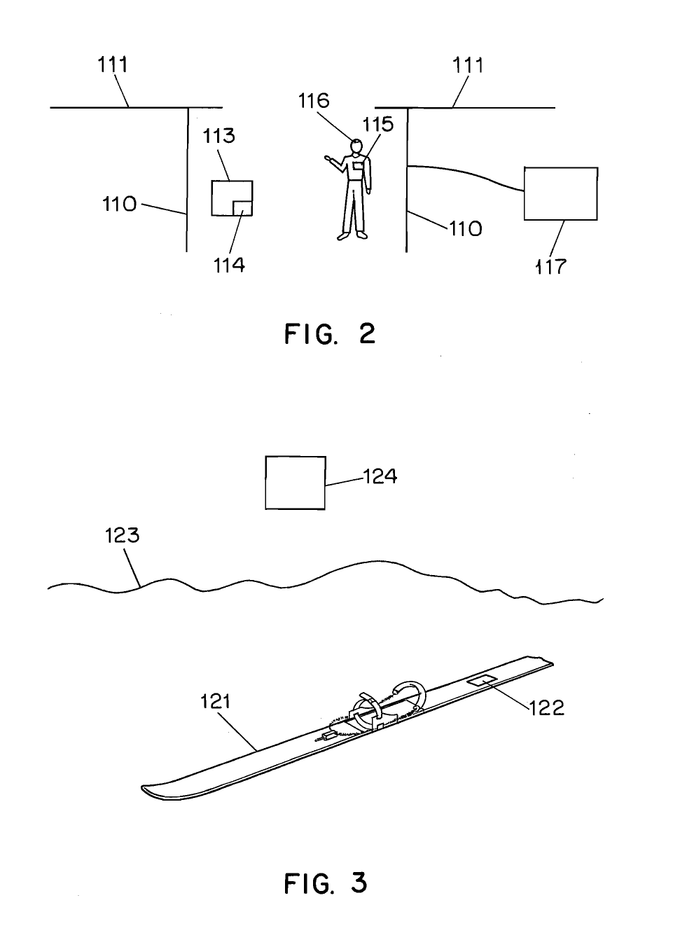

Turning first to FIG. 1, what is shown in perspective view is a portal 112 defined by walls 111 with an antenna 110. The portal can for example be at an entrance to a building, said building omitted for clarity in FIG. 1. The portal can for example be at an entrance to a ski storage area, said ski storage area omitted for clarity in FIG. 1. FIG. 2 shows in schematic plan view the portal of FIG. 1 along with a human user 116 and an asset 113. the antenna 110 is coupled to equipment 117 which sends and receives information to and from tags 114 (attached to asset 113) and 115 (attached to human user 116). The asset may be, for example, a computer such as a notebook computer, or may be a ski, or any of myriad other types of asset.

FIG. 3 shows a ski 121 according to the invention, with snow 123. The ski 121 has a low-frequency tag 122. Transceiver apparatus 124 is able to search for, and preferably to detect, the tag 122 and thus the ski 121, despite the presence of snow 123.

The tags employed can be those described in US 2007/0115132, published May 24, 2007, incorporated herein by reference for all purposes. The RF technology can be that described in US 2007/0063895, published Mar. 22, 2007, incorporated herein by reference for all purposes. The tag technology can be that described in U.S. Pat. No. 7,049,963, issued May 23, 2006, incorporated herein by reference for all purposes. The transceiver communicating with the tags can be that described in US 2007/0120649, published May 31, 2007, incorporated herein by reference for all purposes.

It will thus be appreciated that in one embodiment of the invention, a system comprises a portal through which a user and an asset may pass; a plurality of assets, each having a respective radio tag affixed thereto, each respective radio tag having a respective unique identifier; a plurality of users, each having a respective radio badge affixed thereto, each respective radio badge having a respective unique identifier; an antenna adjacent said portal, the antenna disposed for radio communication with ones of the radio tags when they are nearby thereto and with ones of the radio badges when they are nearby thereto; a server communicatively coupled with the antenna, said server comprising a database associating certain ones of the radio tags with certain respective ones of the badges; said server disposed, upon establishing radio communication with one of the radio tags, and in the event that no radio badge is associated therewith in the database, to annunciate the lack of an associated radio badge; said server disposed, upon establishing radio communication with one of the radio tags, and in the event that a radio badge is associated therewith in the database, and in the event that no radio communication is established with the associated radio badge, to annunciate the lack of the radio badge; said server disposed, upon establishing radio communication with one of the radio tags, and in the event that a radio badge is associated therewith in the database, and in the event that radio communication is established with the associated radio badge, to annunciate the presence of the radio badge.

The annunciation may be a red light or an alarm in the event of the lack of an associated radio badge or in the event of the lack of the radio badge, and may be a green light or a sound other than an alarm in the event of the presence of the radio badge.

The radio communication between the antenna and radio tags may take place at a frequency below one megahertz, and the radio communication between the antenna and radio badges may take place at a frequency below one megahertz.

As mentioned above, the asset may be for example a portable computer or a ski.

The radio tag may lacks a battery and may be powered by RF energy emitted at the portal, the server supplying RF energy therefor at the antenna.

The ski as described above may have a respective radio tag integrally formed with the ski, the respective radio tag comprising a radio transceiver communicating at a frequency below one megahertz, each said respective radio tag having an identifier that is unique with respect to the other apparatus of the plurality of apparatus. If the ski is composed in part of metal, the metal of the ski can advantageously resonate with, or form a portion of, the antenna of the radio tag. Such a ski, if lost in snow, may be located by means of a transceiver that communicates with the radio tag. The same radio tag can provide asset control as described above.

Those skilled in the art will have no difficulty devising myriad obvious variations and improvements upon the invention after having been enabled to do so by the discussion above, all of which are intended to be encompassed within the claims which follow.

1. A system comprising:
a portal through which a user and an asset may pass;
a plurality of assets, each having a respective radio tag affixed thereto, each respective radio tag having a respective unique identifier;
a plurality of users, each having a respective radio badge affixed thereto, each respective radio badge having a respective unique identifier;
an antenna adjacent said portal, the antenna disposed for radio communication with ones of the radio tags when they are nearby thereto and with ones of the radio badges when they are nearby thereto;
a server communicatively coupled with the antenna, said server comprising a database associating certain ones of the radio tags with certain respective ones of the badges;
said server disposed, upon establishing radio communication with one of the radio tags, and in the event that no radio badge is associated therewith in the database, to annunciate the lack of an associated radio badge;
said server disposed, upon establishing radio communication with one of the radio tags, and in the event that a radio badge is associated therewith in the database, and in the event that no radio communication is established with the associated radio badge, to annunciate the lack of the radio badge;
said server disposed, upon establishing radio communication with one of the radio tags, and in the event that a radio badge is associated therewith in the database, and in the event that radio communication is established with the associated radio badge, to annunciate the presence of the radio badge.

2. The system of claim 1 wherein the annunciation comprises illuminating a red light in the event of the lack of an associated radio badge or in the event of the lack of the radio badge, and comprises illuminating a green light in the event of the presence of the radio badge.

3. The system of claim 1 wherein the radio communication between the antenna and radio tags takes place at a frequency below one megahertz, and wherein the radio communication between the antenna and radio badges takes place at a frequency below one megahertz.

4. The system of claim 1 wherein the annunciation comprises sounding an alarm in the event of the lack of an associated radio badge or in the event of the lack of the radio badge, and comprises sounding a sound different from the alarm in the event of the presence of the radio badge.

5. The system of claim 1 wherein the asset is a portable computer.

6. The system of claim 1 wherein the asset is a ski.

7. The system of claim 1 wherein at least one of the radio tags lacks a battery and is powered by RF energy emitted at the portal, the server supplying RF energy therefor at the antenna.

8. A system for use with a plurality of assets, each having a respective radio tag affixed thereto, each respective radio tag having a respective unique identifier, and with a plurality of users, each having a respective radio badge affixed thereto, each respective radio badge having a respective unique identifier, the system comprising:
a portal through which a user and an asset may pass;
an antenna adjacent said portal, the antenna disposed for radio communication with ones of the radio tags when they are nearby thereto and with ones of the radio badges when they are nearby thereto;
a server communicatively coupled with the antenna, said server comprising a database associating certain ones of the radio tags with certain respective ones of the badges;
said server disposed, upon establishing radio communication with one of the radio tags, and in the event that no radio badge is associated therewith in the database, to annunciate the lack of an associated radio badge;
said server disposed, upon establishing radio communication with one of the radio tags, and in the event that a radio badge is associated therewith in the database, and in the event that no radio communication is established with the associated radio badge, to annunciate the lack of the radio badge;
said server disposed, upon establishing radio communication with one of the radio tags, and in the event that a radio badge is associated therewith in the database, and in the event that radio communication is established with the associated radio badge, to annunciate the presence of the radio badge.

9. The system of claim 8 wherein the annunciation comprises illuminating a red light in the event of the lack of an associated radio badge or in the event of the lack of the radio badge, and comprises illuminating a green light in the event of the presence of the radio badge.

10. The system of claim 9 wherein the radio communication between the antenna and radio tags takes place at a frequency below one megahertz, and wherein the radio communication between the antenna and radio badges takes place at a frequency below one megahertz.

11. The system of claim 10 wherein the annunciation comprises sounding an alarm in the event of the lack of an associated radio badge or in the event of the lack of the radio badge, and comprises sounding a sound different from the alarm in the event of the presence of the radio badge.

12. The system of claim 11 wherein the asset is a portable computer.

13. The system of claim 11 wherein the asset is a ski.

14. The system of claim 11 wherein at least one of the radio tags lacks a battery and is powered by RF energy emitted at the portal, the server supplying RF energy therefor at the antenna.

15. A method for use with a portal through which a user and an asset may pass, the portal having an antenna nearby thereto, each user associated with a radio badge, each radio badge having a unique identifier, the method comprising the steps of:
establishing radio communication with a radio tag by means of the antenna, the radio tag affixed to an asset, the radio tag having a unique identifier;
consulting a database communicatively coupled with the antenna, said consultation being in connection with the unique identifier of the radio tag with which radio communication has been established;
in the event that no radio badge is associated in the database with the radio tag with which communication has been established, annunciating the lack of an associated radio tag.

16. A method for use with a portal through which a user and an asset may pass, the portal having an antenna nearby thereto, each user associated with a radio badge, each radio badge having a unique identifier, the method comprising the steps of:
establishing radio communication with a radio tag by means of the antenna, the radio tag affixed to an asset, the radio tag having a unique identifier;
consulting a database communicatively coupled with the antenna, said consultation being in connection with the unique identifier of the radio tag with which radio communication has been established;
in the event that a radio badge is associated in the database with the radio tag with which communication has been established, attempting to establish radio communication with the associated radio badge at the antenna;
in the event that no radio communication is established with the associated radio badge, annunciating the lack of the associated radio tag.

17. A method for use with a portal through which a user and an asset may pass, the portal having an antenna nearby thereto, each user associated with a radio badge, each radio badge having a unique identifier, the method comprising the steps of:
establishing radio communication with a radio tag by means of the antenna, the radio tag affixed to an asset, the radio tag having a unique identifier;
consulting a database communicatively coupled with the antenna, said consultation being in connection with the unique identifier of the radio tag with which radio communication has been established;
in the event that a radio badge is associated in the database with the radio tag with which communication has been established, attempting to establish radio communication with the associated radio badge at the antenna;
in the event that radio communication is established with the associated radio badge, annunciating the presence of the associated radio tag.

18. The method of claim 15 wherein the annunciation comprises illuminating a red light.

19. The method of claim 16 wherein the annunciation comprises illuminating a red light.

20. The method of claim 17 wherein the annunciation comprises illuminating a green light.

21. The method of claim 15 wherein the annunciation comprises sounding an alarm.

22. The method of claim 16 wherein the annunciation comprises sounding an alarm.

23. The method of claim 15 wherein the step of establishing radio communication includes emitting EF energy to power a radio tag or a radio badge.

24. The method of claim 16 wherein the step of establishing radio communication includes emitting EF energy to power a radio tag or a radio badge.

25. The method of claim 17 wherein the step of establishing radio communication includes emitting EF energy to power a radio tag or a radio badge.

26. A plurality of apparatus, each apparatus comprising a ski and a respective radio tag integrally formed with the ski, the respective radio tag comprising a radio transceiver communicating at a frequency below one megahertz, each said respective radio tag having an identifier that is unique with respect to the other apparatus of the plurality of apparatus.

27. A method comprising the steps of:
losing, in snow, a ski, the ski having a radio tag integrally formed with the ski, the radio tag comprising a radio transceiver communicating at a frequency below one megahertz, the radio tag responsive to interrogation by RF communication;
locating the ski by means of interrogation by directional RF communication.

28. The method of claim 27 carried out with respect to a portal through which a user and a ski may pass, the portal having an antenna nearby thereto, each user associated with a radio badge, each radio badge having a unique identifier, the method comprising the steps, performed before the losing and locating steps, of:
establishing radio communication with the radio tag of the ski by means of the antenna, the radio tag having a unique identifier;
consulting a database communicatively coupled with the antenna, said consultation being in connection with the unique identifier of the radio tag with which radio communication has been established;
in the event that a radio badge is associated in the database with the radio tag with which communication has been established, attempting to establish radio communication with the associated radio badge at the antenna;
in the event that radio communication is established with the associated radio badge, annunciating the presence of the associated radio tag.
